(19) United States
(12) Patent Application Publication
(10) Pub. No.: US 2025/0129196 A1
(43) Pub. Date: Apr. 24, 2025

(54) PHOTOCURABLE COMPOSITIONS AND METHOD OF MANUFACTURING DISPLAY DEVICE

(71) Applicants: Samsung Display Co., LTD., Yongin-si (KR); HANSOL CHEMICAL CO., LTD., Seoul (KR)

(72) Inventors: Hee Chang YOON, Yongin-si (KR); Seung Wook KWON, Yongin-si (KR); Hyo Jeong KWON, Yongin-si (KR); Hyeon Jun SEONG, Seoul (KR); Joo Han WOO, Seoul (KR); Hae Sim YOON, Seoul (KR); Kwang Deok LEE, Seoul (KR); Sung Min HA, Seoul (KR); Woo Yong SUNG, Yongin-si (KR); Seung Yong SONG, Yongin-si (KR); Seung Yeon CHAE, Yongin-si (KR)

(21) Appl. No.: 18/795,940

(22) Filed: Aug. 6, 2024

(30) Foreign Application Priority Data
Oct. 24, 2023 (KR) 10-2023-0143124

(51) Int. Cl. C08F 265/06; C08F 2/50; C08K 5/00

(52) U.S. Cl. CPC C08F 265/06; C08F 2/50; C08K 5/005

(57) ABSTRACT

A photocurable composition includes: a photocurable oligomer; a photocurable monomer including a monofunctional (metha)acrylate monomer and a polyfunctional (metha)acrylate monomer; a functional raw material including an antioxidant and a surface additive; and a photoinitiator. The photocurable oligomer may include at least one of (metha)acrylate, polyester-based (metha)acrylate, epoxy (metha)acrylate, or urethane (metha)acrylate. The photocurable oligomer may be included in an amount of about 15 wt % to about 25 wt %, based on a total weight of the photocurable composition, and have a weight-average molecular weight of about 500 g/mol to about 10000 g/mol.

### CROSS-REFERENCE TO RELATED APPLICATION

The present application claims priority to and the benefit of Korean Patent Application No. 10-2023-0143124, filed on Oct. 24, 2023, in the Korean Intellectual Property Office, the entire content of which is incorporated herein by reference.

### BACKGROUND

### 1. Field

Embodiments of the present disclosure described herein are related to photocurable compositions and a method of manufacturing a display device.

### 2. Description of the Related Art

With the development of information technologies, the importance of a display device, which is a connection medium between information and a user, increases. Accordingly, display devices, such as an organic light emitting display device (OLED), a liquid crystal display device (LCD), an electrophoretic display device, and/or a quantum dot display device, are increasingly utilized.

A display device may be manufactured by forming a plurality of panels on a mother substrate and then cutting the mother substrate. In order to improve reliability in a manufacturing process, a strategy, design, and/or plan for disposing a protective film over the plurality of panels may be applied or pursued.

### SUMMARY

Aspects according to one or more embodiments of the present disclosure are directed toward photocurable compositions and a method of manufacturing a display device, utilizing photocurable compositions, which can simplify a manufacturing process of a protective film for protecting a panel in a manufacturing process of the display device.

Aspects according to one or more embodiments of the present disclosure are directed toward photocurable compositions and a method of manufacturing a display device, utilizing photocurable compositions, which can minimize or reduce a property change of a protective film under a harsh environment (e.g., a high temperature and humid environment).

Additional aspects will be set forth in part in the description which follows and, in part, will be apparent from the description, or may be learned by practice of the presented embodiments of the present disclosure.

According to one or more embodiments of the present disclosure, a photocurable composition may include: a photocurable oligomer; a photocurable monomer including a monofunctional (metha)acrylate monomer and a polyfunctional (metha)acrylate monomer; a functional raw material including an antioxidant and a surface additive; and a photoinitiator, wherein the photocurable oligomer includes at least one of (metha)acrylate, polyether-based (metha)acrylate, epoxy (metha)acrylate, or urethane (metha)acrylate, and wherein the photocurable oligomer is included in an amount of about 15 wt % to about 25 wt %, based on a total weight of the photocurable composition, and has a weight-average molecular weight of about 500 g/mol to about 10000 g/mol.

According to one or more embodiments, the monofunctional (metha)acrylate monomer may include at least one of 2-hydroxyethyl (metha)acrylate, 2-hydroxypropyl (metha)acrylate, 4-hydroxybutyl acrylate, methyl(metha)acrylate, n-butyl (metha)acrylate, t-butyl(metha)acrylate, isobutyl(metha)acrylate, n-hexyl (metha)acrylate, stearyl(metha)acrylate, lauryl(metha)acrylate, isononylacrylate, tridecyl(metha)acrylate, cyclohexyl(metha)acrylate, norbornyl(metha)acrylate, isobornyl(metha)acrylate, norbornanyl(metha)acrylate, dicyclopentenyl(metha)acrylate, dicyclopentenyloxyethyl(metha)acrylate, dicyclopentanyl(metha)acrylate, or dicyclopentanyloxyethyl(metha)acrylicvinylnorbornylon. The polyfunctional (metha)acrylate monomer may include at least one of ethyleneglycoldimethacrylate, diethyleneglycoldimethacrylate, 1,6-hexanedioldimethacrylate, trimethylolpropanetrimethacrylate, pentaerythritol tetraacrylate, dipentaerythritolpenta (metha)acrylate, dipentaerythritomonohydroxypenta (metha)acrylate, or dipropyleneglycoldiacrylate.

According to one or more embodiments, the monofunctional (metha)acrylate monomer may be included in an amount of about 65 wt % to about 75 wt %, based on the total weight of the photocurable composition. The polyfunctional (metha)acrylate monomer may be included in an amount of about 1 wt % to about 50 wt %, based on the total weight of the photocurable composition.

According to one or more embodiments, the photocurable monomer may have a viscosity in a range of about 1 cps to about 1000 cps under about 25° C.

According to one or more embodiments, the antioxidant may include at least one selected from the group consisting of IRGANOX 1135, IRGANOX 1035, IRGANOX 1520L, IRGANOX 1076, IRGANOX 1010, IRGAFOS 168, and IRGAFOS 126 which are manufactured by IGA (IGM Resins B.V.) and/or 2,2′-thiodiethylene bis [3-(3,5-di-tert-butyl-4-hydroxyphenyl) propionate].

According to one or more embodiments, the antioxidant may be included in an amount of about 0.001 wt % to about 5 wt %, based on the total weight of the photocurable composition.

According to one or more embodiments, the surface additive may include at least one of a polyacrylate-based surfactant, a silicon containing surfactant, or an acrylic-based surfactant.

According to one or more embodiments, the surface additive may be included in an amount of about 0.1 wt % to about 5 wt %, based on the total weight of the photocurable composition.

According to one or more embodiments, the photoinitiator may include at least one of benzophenone, benzyl, benzoin, acetophenone, 2,2-diethoxyacetophenone, 2,2-dimethoxy-2-phenylacetophenone, p-dimethylaminoacetophenone, p-dimethylaminopropiophenone, p,p′-bisdiethylaminobenzophenone, benzoinmethylether, benzoinisobutylether, benzoin-n-butylether, 1-hydroxycyclohexylphenylketone, 2-hydroxy-2-methyl-1-phenyl-propane-1-on, 1-(4-isopropylphenyl)-2-hydroxy-2-methylpropane-1-on, 2,2-diethoxyacetophenone, 4-N,N′-dimethylacetophenone, benzoquinone, anthraquinone, diphenyldisulfide, dibenzyldisulfide, tetraethylthiuramdisulfide, tetramethylammoniummonosulfide, azobisisobutyronitryl, 2,2′-azobispropane, hydrazine, thioxanthone, 2-methylthioxanthone peroxidebenzoyl, di-t-butylperoxide, 2,4,6-trimethylbenzoyl-diphenyl-phosphineoxide, 2-methyl-1-[4-(methylthio)phenyl]-2-morpholino-propane-1-on, 2-hydroxy-1-4-[4-(2-hydroxy-2-methyl-prophionyl)-benzyl]-phynyl-2-methyl-propane-1-on, methyl phenylglyoxylate, 2-benzly-2-(dimethylamino)-1-[4-(4-morpholinyl)phenyl]-1-butanone, or 2-methyl-1-[4-(methylthio)phynly]-2-(4-morpholinyl)-1-propanone.

According to one or more embodiments, the photoinitiator may be included in an amount of about 0.1 wt % to about 10 wt %, based on the total weight of the photocurable composition.

According to one or more embodiments of the present disclosure, a method of manufacturing a display device may include: forming (or providing) panels on a mother substrate; and forming (or providing) a protective film on the top of each of the panels, wherein the forming (or providing) of the protective film on the top of each of the panels includes: applying a photocurable composition on the top of each of the panels, utilizing an ink-jet printing apparatus; and photocuring the photocurable composition, wherein the photocurable composition includes: a photocurable oligomer; a photocurable monomer including a monofunctional (metha)acrylate monomer and a polyfunctional (metha)acrylate monomer; a functional raw material including an antioxidant and a surface additive; and a photoinitiator, wherein the photocurable oligomer includes at least one of (metha)acrylate, polyether-based (metha)acrylate, epoxy (metha)acrylate, or urethane (metha)acrylate, and wherein the photocurable oligomer is included in an amount of about 15 wt % to about 25 wt %, based on a total weight of the photocurable composition, and has a weight-average molecular weight of about 500 g/mol to about 10000 g/mol.

According to one or more embodiments, the monofunctional (metha)acrylate monomer may be included in an amount of about 65 wt % to about 75 wt %, based on the total weight of the photocurable composition. The polyfunctional (metha)acrylate monomer may be included in an amount of about 1 wt % to about 50 wt %, based on the total weight of the photocurable composition.

According to one or more embodiments, the antioxidant may include at least one of a phenol-based antioxidant, a phosphor-based antioxidant, or a sulfur-based antioxidant, and be included in an amount of about 0.001 wt % to about 5 wt %, based on the total weight of the photocurable composition. The surface additive may include at least one of a polyacrylate-based surfactant, a silicon containing surfactant, or acrylic-based surfactant, and be included in an amount of about 0.1 wt % to about 5 wt %, based on the total weight of the photocurable composition.

According to one or more embodiments, the photoinitiator may include at least one of a phosphine-based photoinitiator, a hydroxy ketone-based photoinitiator, a carbonyl-based photoinitiator, a sulfide-based photoinitiator, a quinone-based photoinitiator, an azo-based photoinitiator, or a peroxide-based photoinitiator, and be included in an amount of about 0.1 wt % to about 10 wt %, based on the total weight of the photocurable composition.

According to one or more embodiments, the photocuring of the photocurable composition may include curing the photocurable composition utilizing ultraviolet light. The ultraviolet light may have a wavelength of about 350 nanometer (nm) to about 400 nm, and have a cumulative light quantity of about 3 joules per centimeter squared (J/cm²) to about 5 J/cm².

According to one or more embodiments, the photocuring of the photocurable composition, the photocurable composition may be cured under an oxygen concentration of about 100 parts per minute (ppm) to about 5000 ppm.

According to one or more embodiments, the method may further include removing the protective film. The removing of the protective film may include removing the protective film utilizing a tape including at least one of a thermal exfoliation tape, an ultraviolet exfoliation tape, or a weak adhesive tape. When the protective film is removed, an exfoliation strength of the protective film may become smaller as approaching a central area of the protective film.

According to one or more embodiments, the photocurable composition may have a viscosity of about 15 centipoise (cps) to 25 cps and a surface tension of about 20 dyne/cm to about 30 dyne/cm under 25° C. In the applying the photocurable composition on the top of each of the panels utilizing the ink-jet printing apparatus, the photocurable composition may be applied through a head of the ink-jet printing apparatus. The head may have a temperature range of about 30° C. to about 50° C.

According to one or more embodiments, the protective film may be formed (or provided) to have a thickness of about 30 micrometers (μm) to about 150 μm.

According to one or more embodiments, the protective film may have a curing index of about 85% to about 95% in a Fourier-transform infrared spectroscopy (FT-IR) measurement and a hardness of about 0.7 giga pascal (GPa) to about 2 GPa.

### BRIEF DESCRIPTION OF THE DRAWINGS

FIG. 1 is a schematic plan view illustrating a display device in accordance with some embodiments of the present disclosure.

FIG. 2 is a schematic cross-sectional view illustrating the display device in accordance with some embodiments of the present disclosure.

1 FIG. 3 is a schematic flowchart illustrating a method of manufacturing the display device in accordance with some embodiments of the present disclosure.

FIG. 4 is a schematic plan view illustrating step S100 shown in FIG. 3.

FIG. 5 is a schematic cross-sectional view taken along line A-A′ shown in FIG. 4.

FIG. 6 is a schematic flowchart illustrating step S200 shown in FIG. 3.

FIGS. 7 and 8 are schematic cross-sectional views illustrating process steps shown in FIG. 5.

FIG. 9 is a schematic plan view illustrating step S300 shown in FIG. 3.

FIG. 10 is a schematic cross-sectional view illustrating step S400 shown in FIG. 3.

FIG. 11 is an enlarged view schematically illustrating a panel and a protective film.

### DETAILED DESCRIPTION

The present disclosure may be modified in one or more suitable manners and have many forms, and thus specific embodiments will be illustrated in the drawings and described in more detail in the detailed description of the present disclosure. It should be understood, however, that it is not intended to limit the present disclosure to the particular forms disclosed, but rather, is intended to cover all modifications, equivalents, and alternatives falling within the spirit and scope of the present disclosure.

It will be understood that, although the terms “first”, “second,” etc. may be utilized herein to describe one or more suitable elements, these elements should not be limited by these terms. These terms are only utilized to distinguish one element from another element. Thus, a “first” element discussed herein could also be termed a “second” element without departing from the teachings of the present disclosure. As utilized herein, the singular forms are intended to include the plural forms as well, unless the context clearly indicates otherwise.

It will be further understood that the terms “includes” and/or “including,” when utilized in this specification, specify the presence of stated features, integers, steps, operations, elements, and/or components, but do not preclude the presence and/or addition of one or more other features, integers, steps, operations, elements, components, and/or groups thereof. Further, an expression that an element such as a layer, region, substrate or plate is placed “on” or “above” another element indicates not only a case where the element is placed “directly on” or “just above” the other element but also a case where a further element is interposed between the element and the other element. In contrast, an expression that an element such as a layer, region, substrate or plate is placed “beneath” or “below” another element indicates not only a case where the element is placed “directly beneath” or “just below” the other element but also a case where a further element is interposed between the element and the other element.

In the present disclosure, “(metha)acrylate” refers to acrylate or methacrylate, “(metha) acryl” refers to acryl or methacryl, and “(metha) acryloyl refers to acryloyl or methacryloyl

In the present disclosure, a monomer refers to a compound which is distinguished from an oligomer and has a weight-average molecular weight of less than about 500. The oligomer refers to a compound having a weight-average molecular weight of about 500 or more.

In the present disclosure, a “polymerizable functional group” is a group involved in a polymerization reaction, and may be, for example, a (metha)acrylate group.

The present disclosure generally relates to photocurable compositions and a method of manufacturing a display device. Hereinafter, photocurable compositions and a method of manufacturing a display device in accordance with some embodiments of the present disclosure will be described with reference to the accompanying drawings.

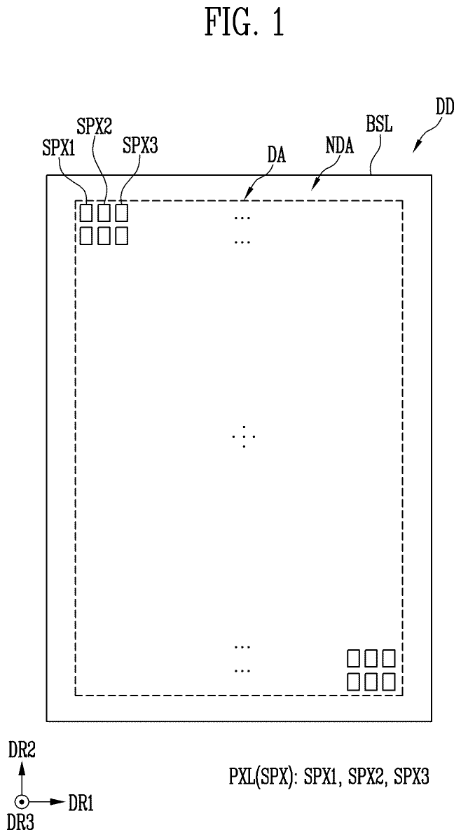

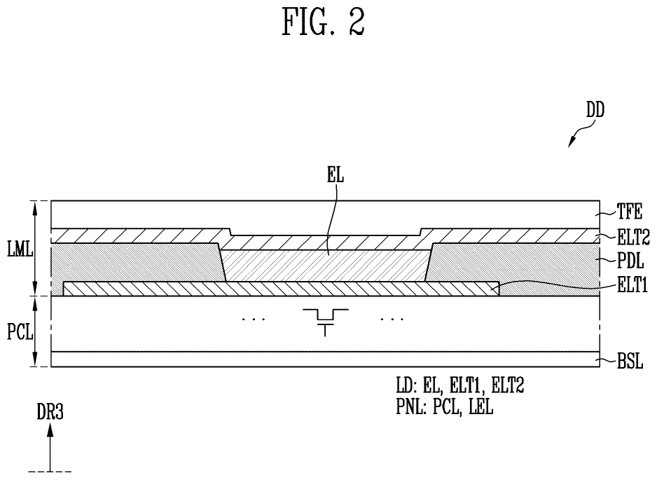

First, a display device DD capable of being manufactured according to a method of manufacturing a display device in accordance with the present disclosure will be described with reference to FIGS. 1 and 2. FIG. 1 is a schematic plan view illustrating a display device in accordance with some embodiments of the present disclosure. FIG. 2 is a schematic cross-sectional view illustrating the display device in accordance with some embodiments of the present disclosure.

Referring to FIG. 1, the display device DD may be configured to emit light. The display device DD may include a light emitting element LD (see FIG. 2). In some embodiments, the display device DD may be a device which displays moving images or still images. The display device DD may be utilized as a display screen of not only portable electronic devices such as a mobile phone, a smart phone, a tablet personal computer (PC), a smart watch, and/or a watch phone, but also one or more suitable products such as a television, a notebook computer, a monitor, an advertisement board, Internet of things (IOT), and/or a micro display. However, the application field of the display device DD is not limited to a specific example.

The display device DD may be formed (or provided) in a rectangular plane having short sides in a first direction DR1 and long sides in a second direction DR2 intersecting or crossing the first direction DR1. A corner at which the short side in the first direction DR1 and the long side in the second direction DR2 meet each other may be formed (or provided) round to have a set or predetermined curvature or be formed (or provided) at a right angle. The planar shape of the display device DD is not limited to a quadrangular shape, and the display device DD may be formed (or provided) in a round shape such as another polygonal shape, a circular shape, or an elliptical shape. The display device DD may be formed (or provided) flat, but the present disclosure is not limited thereto. For example, the display device DD may include a curved portion which is formed (or provided) at a left/right end and has a constant curvature or a changing curvature. In some embodiments, the display device DD may be formed (or provided) flexible enough to be warpable, curvable, bendable, foldable or rollable.

In the present disclosure, the first direction DR1 may be a “horizontal” direction as a row direction of pixels PXL. The second direction DR2 may be a column direction of pixels PXL. A third direction DR3 may be a display direction of the display device DD or a normal (e.g., perpendicular) direction of a plane on which a base layer BSL is disposed.

The display device DD may include a display area DA and a non-display area NDA. The non-display area NDA may refer to an area except the display area DA. The non-display area NDA may surround at least a portion of the display area DA.

The display area DA may refer to an area in which pixels PXL are disposed. The non-display area NDA may refer to an area in which the pixels PXL are not disposed. A driving circuit, lines, and pads, which are connected to the pixels PXL of the display area DA, may be disposed in the non-display area NDA.

In some embodiments, each pixel PXL (or sub-pixels SPX) may include a first sub-pixel SPX1, a second sub-pixel SPX2, and a third sub-pixel SPX3. At least one first sub-pixel SPX1, at least one second sub-pixel SPX2, and at least one third sub-pixel SPX3 may constitute one pixel unit PXU capable of emitting lights of one or more suitable colors. In FIG. 1, each pixel PXL includes three sub-pixels SPX1, SPX2, and SPX3, i.e., a first sub-pixel SPX1, a second sub-pixel SPX2, and a third sub-pixel SPX3. The embodiment of the present disclosure is not limited thereto.

In some embodiments, the pixels PXL (or sub-pixels SPX) may be arranged according to a stripe arrangement structure, a PENTILE™ arrangement structure, and/or the like. However, the present disclosure is not limited thereto.

The first sub-pixel SPX1 may be configured to emit first light, the second sub-pixel SPX2 may be configured to emit second light, and the third sub-pixel SPX3 may be configured to emit third light. The first light may be light in a red wavelength band, the second light may be light in a green wavelength band, and the third light may be light in a blue wavelength band. The red wavelength band may be a wavelength band of about 600 nm to about 750 nm, the green wavelength band may be a wavelength band of about 480 nm to about 560 nm, and the blue wavelength band may be a wavelength band of about 370 nm to about 460 nm. However, the embodiment of the present disclosure is not limited thereto.

Each of the first sub-pixel SPX1, the second sub-pixel SPX2, and the third sub-pixel SPX3 is a light emitting element capable of emitting light, and may include an inorganic light emitting element including an inorganic semiconductor or an Organic Light Emitting Diode (OLED) emitting light. However, the present disclosure is not limited to a specific example.

Referring to FIG. 2, the display device DD may include a panel PNL. The panel PNL may include a pixel circuit layer PCL and a light emitting element layer LEL.

The pixel circuit layer PCL may be a layer including a pixel circuit for driving light emitting elements LD. The pixel circuit layer PCL may include the base layer BSL, conductive layers for forming (or providing) pixel circuits, and insulating layers disposed between the conductive layers.

In some embodiments, the pixel circuit may include at least one transistor, and be electrically connected to the light emitting elements LD to provide an electrical signal for allowing the light emitting elements LD to emit light.

The light emitting element layer LEL may be disposed on the pixel circuit layer PCL. In some embodiments, the light emitting element layer LEL may include at least one light emitting element LD, a pixel defining layer PDL, and an encapsulation layer TFE.

The light emitting element LD may be disposed on the pixel circuit layer PCL. In some embodiments, the light emitting element LD may include a first electrode ELT1, a light emitting portion EL, and a second electrode ELT2.

One surface of the light emitting portion EL may be electrically connected to the first electrode ELT1, and the other surface of the light emitting portion EL may be electrically connected to the second electrode ELT2.

The first electrode ELT may be an anode electrode of the light emitting portion EL, and the second electrode ELT2 may be a cathode electrode of the light emitting portion EL. In some embodiments, the first electrode ELT1 and the second electrode ELT2 may include a conductive material. For example, the first electrode ELT1 may include a conductive material having a reflective property, and the second electrode ELT2 may include a transparent conductive material. However, the present disclosure is not necessarily limited thereto. The first electrode ELT1 may be the cathode electrode of the light emitting portion EL, and the second electrode ELT2 may be the anode electrode of the light emitting portion EL.

The light emitting portion EL may be configured to emit light, based on an electrical signal provided from the anode electrode (e.g., the first electrode ELT1) and the cathode electrode (e.g., the second electrode ELT2).

The pixel defining layer PDL may be disposed over the first electrode ELT1. The pixel defining layer PDL may define a position at which the light emitting portion EL is disposed.

The pixel defining layer PDL may include an inorganic material. For example, the inorganic material may include at least one selected from the group consisting of silicon nitride (SiNₓ), silicon oxide (SiOₓ), silicon oxynitride (SiOₓN_{y}), and aluminum oxide (AlOₓ). However, the present disclosure is not limited thereto. The pixel defining layer PDL may include an organic material. For example, the pixel defining layer PDL may include at least one selected from the group consisting of acrylic resin, epoxy resin, phenolic resin, polyamide resin, and polyimide resin.

At least a portion of the second electrode ELT2 may be disposed on the light emitting portion EL. The at least a portion of the second electrode ELT2 may be disposed directly on the light emitting portion EL. The at least a portion of the second electrode ELT2 may cover the light emitting portion EL.

The encapsulation layer TFE may be disposed over the light emitting element LD (e.g., the second electrode ELT2). The encapsulation layer TFE may cancel or reduce a step difference caused by the light emitting element LD and the pixel defining layer PDL. The encapsulation layer TFE may include a plurality of insulating layers covering the light emitting element LD. In some embodiments, the encapsulation layer TFE may have a structure in which an inorganic layer and an organic layer are alternately stacked. In some embodiments, the encapsulation layer TFE may be a thin film encapsulation layer.

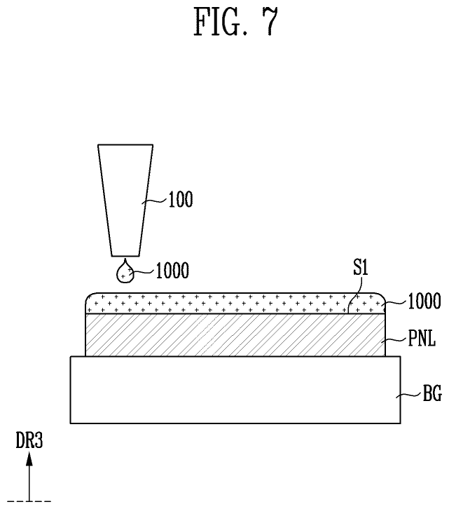

In some embodiments, when the panel PNL is manufactured, a protective film PF (see FIG. 8) may be disposed on the encapsulation layer TFE. The protective film PF may protect the panel PNL of the display device DD. The protective film PF may be manufactured (e.g., formed) utilizing a photocurable composition 1000 (see FIG. 7).

Hereinafter, the photocurable composition 1000 in accordance with the present disclosure will be described.

The photocurable composition 1000 is a composition for manufacturing the protective film PF. The photocurable composition 1000 may be cured to form (or provide) the protective film PF.

The photocurable composition 1000 may include a photocurable material. The photocurable composition 1000 may be cured by ultraviolet (UV) light.

The photocurable composition 1000 may be a resin for ink-jet printing. The photocurable composition 1000 may be discharged on the encapsulation layer TFE by an ink-jet printing device. However, the present disclosure is not limited thereto. For example, the photocurable composition 1000 may be supplied on the encapsulation layer TFE by another process method for supplying the resin in addition to ink-jet printing.

In some embodiments, the photocurable composition 1000 may include an oligomer, a monomer, a functional raw material, and a photoinitiator. Hereinafter, a configuration of the photocurable composition 1000 will be described in more detail.

### (1) Oligomer

The oligomer may include a photocurable oligomer (e.g., a photocurable type or kind monomer). The oligomer is a main component forming (or providing) a coating film after photopolymerization in the photocurable composition 1000, and may form (or provide) a crosslinked structure, thereby controlling a modulus property, a flexible property, an adhesive property, a film property, and/or the like of a cured product (e.g., the protective film PF).

The oligomer may include at least one of (metha)acrylate, polyether-based (metha)acrylate, epoxy (metha)acrylate, or urethane (metha)acrylate.

The oligomer may have a weight-average molecular weight of about 500 g/mol to about 10000 g/mol.

In some embodiments, the oligomer may be a compound including a functional group represented by the following Chemical Formula 1. In some embodiments, the oligomer may be a central carbon compound or a compound in which the functional group represented by the following Chemical Formula 1 is disposed at both (e.g., opposite) ends of the central carbon compound. In some embodiments, the central carbon compound is a material of a hydrocarbon base, and the number of carbons may be controlled or selected such that the weight-average molecular weight of the oligomer becomes about 500 g/mol to about 10000 g/mol.

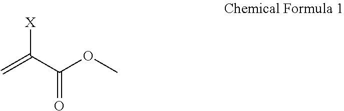

In some embodiments, X in Chemical Formula 1 may be hydrogen (H) or a methyl group.

In some embodiments, when the oligomer includes urethane (metha)acrylate, the urethane (metha)acrylate may be prepared by reacting diol having hydroxyl groups at both (e.g., opposite) ends of a molecule, (metha)acrylate having a hydroxyl group in a molecule, and a compound having an isocyanate group under existence of a catalyst.

For example, the diol having the hydroxyl groups at both (e.g., opposite) the ends of the molecule may be at least one selected from the group consisting of polyethylene oxide, polyethylene glycol, polytetramethylene oxide, polypropylene oxide, polyisobutylene, polyethylene adipate, and polycaprolactone.

For example, the (metha)acrylate having the hydroxyl group in the molecule may be at least one selected from the group consisting of 2-hydroxyethyl (metha)acrylate, 2-hydroxyisopropyl (metha)acrylate, 4-hydroxybutyl(metha)acrylate, caprolactone ring-opening hydroxyacrylate, pentaerythritol tri (metha)acrylate, pentaerythritol tetra(metha)acrylate, dipentaerythritol penta(metha)acrylate, and dipentaerythritol hexa(metha)acrylate.

For example, the compound having the isocyanate group may be at least one selected from the group consisting of 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylenebis(cyclohexyl isocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis(2,6-dimethylphenyl isocyanate), 4,4′-oxybis(phenyl isocyanate), tri-functional isocyanate derived from hexamethylene diisocyanate, and trimethane propanol adduct toluene diisocyanate.

The oligomer may be included in an amount of about 1 wt % to about 50 wt %, based on a total weight of the photocurable composition 1000. In some embodiments, the oligomer may be included in an amount of about 15 wt % to about 25 wt %, based on the total weight of the photocurable composition 1000. When the oligomer is included in an amount of less than about 1 wt %, based on the total weight of the photocurable composition 1000, it may be difficult to ensure the film property when the protective film PF is formed (or provided). When the oligomer is included in an amount of exceeding about 50 wt %, based on the total weight of the photocurable composition 1000, the viscosity of the photocurable composition 1000 may increase. Therefore, it may be difficult for the photocurable composition 1000 to be discharged from an ink-jet printing apparatus 100 (see FIG. 7), and the manufacturing time of the display device DD may be increased.

### (2) Monomer

The monomer may be a photocurable monomer (e.g., a photocurable type or kind monomer). The monomer along with the oligomer is a main component forming (or providing) the coating film after photopolymerization in the photocurable composition 1000, and may include at least one (metha)acrylate functional group in a molecule. The monomer may control the viscosity of the photocurable composition 1000, and control the hardness of a cured product. For example, the monomer may form (or provide) an appropriate or suitable viscosity with which the photocurable composition 1000 is discharged from the ink-jet printing apparatus 100, and may allow the cured product to have an appropriate or suitable hardness for protecting the panel PNL.

The monomer may have a viscosity in a range of about 1 cps to about 1000 cps under about 25° C. When the monomer has the viscosity in the above-described numerical range, the photocurable composition 1000 can be appropriately discharged from the ink-jet printing apparatus 100.

The monomer may include at least one of a monofunctional (metha)acrylate monomer or a polyfunctional (metha)acrylate monomer including at least two metha (acrylate) functional groups.

The monofunctional (metha)acrylate monomer may include at least one selected from the group consisting of a monofunctional (metha)acrylate monomer having a polar hydroxyl group in a molecule, a monofunctional (metha)acrylate monomer having no polar group in a molecule, and a monofunctional metha (acrylate) monomer having an ethylenically unsaturated double bond and an annular aliphatic group in a molecule.

For example, the monofunctional (metha)acrylate monomer having the polar hydroxyl group in the molecule may include at least one selected from the group consisting of 2-hydroxyethyl (metha)acrylate, 2-hydroxypropyl (metha)acrylate, and 4-hydroxybutyl acrylate.

The monofunctional (metha)acrylate monomer having no polar group in the molecule may have a straight chain structure. For example, the monofunctional (metha)acrylate monomer having no polar group in the molecule may include at least one selected from the group consisting of methyl(metha)acrylate, n-butyl (metha)acrylate, t-butyl(metha)acrylate, isobutyl(metha)acrylate, n-hexyl (metha)acrylate, stearyl(metha)acrylate, lauryl(metha)acrylate, isononylacrylate, and tridecyl(metha)acrylate.

The monofunctional metha (acrylate) monomer having the ethylenically unsaturated double bond and the annular aliphatic group in the molecule is a photopolymerization monomer, and may include, for example, at least one of materials having a vinyl group, such as cyclohexyl(metha)acrylate, norbornyl(metha)acrylate, isobornyl(metha)acrylate, norbornanyl(metha)acrylate, dicyclopentenyl(metha)acrylate, dicyclopentenyloxyethyl(metha)acrylate, dicyclopentanyl(metha)acrylate, dicyclopentanyloxyethyl(metha)acrylicvinylnorbornylon, and vinylnorvornylnan.

For example, the polyfunctional (metha)acrylate monomer may include at least one selected from the group consisting of ethyleneglycoldimethacrylate, diethyleneglycoldimethacrylate, 1,6-hexanedioldimethacrylate, trimethylolpropanetrimethacrylate, pentaerythritol tetraacrylate, dipentaerythritolpenta (metha)acrylate, dipentaerythritomonohydroxypenta(metha)acrylate, and dipropyleneglycoldiacrylate.

The monofunctional (metha)acrylate monomer may be included in an amount of about 10 wt % to about 97.699 wt %, based on the total weight of the photocurable composition 1000. In some embodiments, the monofunctional (metha)acrylate monomer may be included in an amount of about 10 wt % to about 100 wt %, based on a weight of the photocurable composition 1000 except the photoinitiator. In some embodiments, the monofunctional (metha)acrylate monomer may be included in an amount of about 10 wt % to about 100 wt %, based on the total weight of the photocurable composition 1000. When the monofunctional (metha)acrylate monomer is included in an amount of about 100 wt %, based on the total weight of the photocurable composition 1000, the photocurable composition 1000 may be configured with only the monofunctional (metha)acrylate monomer.

In some embodiments, the monofunctional (metha)acrylate monomer may be included in an amount of about 65 wt % to about 75 wt %, based on the total weight of the photocurable composition 1000. The monofunctional (metha)acrylate monomer may control the viscosity of the photocurable composition 1000. Therefore, when the monofunctional (metha)acrylate monomer is included in an amount of less than about 10 wt %, based on the total weight of the photocurable composition 1000, it may be difficult to ensure a viscosity with which the photocurable composition 1000 is discharged from the ink-jet printing apparatus 100, and it may be difficult for the photoinitiator to be dissolved in the photocurable composition 1000.

The polyfunctional (metha)acrylate monomer may be included in an amount of about 1 wt % to about 50 wt %, based on the total weight of the photocurable composition 1000. In some embodiments, the polyfunctional (metha)acrylate monomer may be included in an amount of about 5 wt % to about 10 wt %, based on the total weight of the photocurable composition 1000. The polyfunctional (metha)acrylate monomer may control the hardness of a cured product formed (or provided) from the photocurable composition 1000. Therefore, when the polyfunctional (metha)acrylate monomer is included in an amount of less than about 1 wt %, based on the total weight of the photocurable composition 1000, it may be difficult to ensure the hardness of the cured product (e.g., the cured product may not be cured). When the polyfunctional (metha)acrylate monomer is included in an amount of exceeding about 50 wt %, based on the total weight of the photocurable composition 1000, the cured product may be broken as the cured product is highly hardened.

### (3) Functional Raw Material

The functional raw material may include an antioxidant and a surface additive.

The antioxidant may include at least one of a radical chain inhibitor or a peroxide decomposer.

The radical chain inhibitor may remove radicals additionally generated after curing, thereby preventing or reducing performance of a radical chain reaction. The radical chain inhibitor is a primary antioxidant, and may include a phenol-based antioxidant.

The phenol-based antioxidant is a primary antioxidant, and may include, for example, at least one selected from the group consisting of IRGANOX 1135, IRGANOX 1035, IRGANOX 1520L, IRGANOX 1076, and IRGANOX 1010, which are manufactured by IGA (IGM Resins B.V.) and/or 2,2′-thiodiethylene bis [3-(3,5-di-tert-butyl-4-hydroxyphenyl) propionate].

The peroxide decomposer may include at least one of a phosphor-based antioxidant as a secondary antioxidant or a sulfur-based antioxidant as a tertiary antioxidant. The peroxide decomposer may decompose generated hydroperoxide in a form (e.g., an ion) in which no radical is generated.

The phosphor-based antioxidant may include at least one selected from the group consisting of IRGAFOS 168 and IRGAPOS 126, which are manufactured by IGA. The sulfur-based antioxidant may include, for example, thiol ester.

In some embodiments, the antioxidant may be a phenol-based antioxidant. However, the present disclosure is not limited thereto. In some embodiments, the antioxidant may concurrently (e.g., simultaneously) have a phenol-based antioxidant functional group and a phosphor-based antioxidant function group in one molecule, or concurrently (e.g., simultaneously) have a phenol-based antioxidant functional group and a sulfur-based antioxidant function group in one molecule.

In some embodiments, the antioxidant may be 2,2′-thiodiethylene bis [3-(3,5-di-tert-butyl-4-hydroxyphenyl) propionate].

The antioxidant may be included in an amount of about 0.001 wt % to about 5 wt %, based on the total weight of the photocurable composition 1000. In some embodiments, the antioxidant may be included in an amount of about 0.05 wt % to about 0.5 wt %, based on the total weight of the photocurable composition 1000.

The antioxidant may prevent or reduce the photocurable composition 1000 from being cured by heat. Therefore, when the antioxidant may be included in an amount of less than about 0.001 wt %, based on the total weight of the photocurable composition 1000, the photocurable composition 1000 may be cured at a high temperature (e.g., about 85° C. or higher), and therefore, cracks may occur in a cured product. When the antioxidant may be included in an amount exceeding about 5 wt %, based on the total weight of the photocurable composition 1000, crosslinking of the oligomer or the monomer may be interrupted or reduced.

The surface additive may include, for example, at least one selected from the group consisting of a polyacrylate-based surfactant, a silicon containing surfactant, and acrylic-based surfactant.

For example, the surface additive may be selected from the group consisting of a low molecular weight acidic polyester, an unsaturated polyaminamide salt, a high molecular weight alkylolaminoamide, a high molecular weight block copolymer solution, an alkylammonium salt of a high molecular copolymer, an acrylate copolymer, a hydroxyl functional group carboxylic acid ester, a polyether-modified polydimethylsiloxane, acryl-modified polymethylalkysiloxane, a polyether-modified polydimethylsiloxane, and combinations thereof.

In some embodiments, the surface additive may be selected from the group consisting of BYK-306, BYK-310, BYK-320, BYK-331, BYK-333, BYK-342, BYK-350, BYK-354, BYK-355, BYK-356, BYK-358N, BYK-359, BYK-361N, BYK-381, BYK-370, BYK-371, BYK-378, BYK-388, BYK-392, BYK-394, BYK-399, BYK-3440, BYK-3441, BYK-UV3500, BYK-UV3530, and BYK-UV3570, which are manufactured by BYK, Rad 2100, Rad 2011, Glide 100, Glide 410, and Glide 450, which are manufactured by TEGO, Fluorad FC-93, FC-95, FC-98, FC-129, FC-135, FC-170C, and FC-430, which are manufactured by Sumitoto 3M, or Zonyl FS-300, FSN, FSN-100, and FSO which are manufactured by Dupont, and combinations thereof.

In some embodiments, the surface additive may include at least one selected from the group consisting of BYK-UV3500, BYK-UV3530, and BYK-UV3570, which are manufactured by BYK. When the photocurable composition 1000 includes at least one selected from the group consisting of BYK-UV3500, BYK-UV3530, and BYK-UV3570, which are manufactured by BYK, migration after curing may be decreased. The migration may refer to a phenomenon in which a component (unreacted material) unreacted in the photocurable composition 1000 remains on a surface of the cured product as the component is moved on the surface of the cured produce.

In some embodiments, the surface additive may be a material satisfying the following Chemical Formula 2.

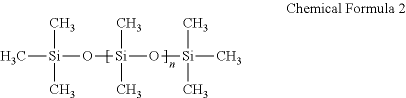

In some embodiments, in Chemical Formula 2, n may be selected in a range in which a weight-average molecular weight of Chemical Formula 2 has about 1000 g/mol to about 100000 g/mol. For example, in some embodiments, n may be a natural number of 1 or more and 3000 or less. When the photocurable composition 100 is applied on the encapsulation layer TFE, the surface additive may improve a leveling property and an application property of the applied photocurable composition 1000, and improve a property that the photocurable composition 100 is exfoliated from the encapsulation layer TFE after curing.

The surface additive may be included in an amount of about 0.1 wt % to about 5 wt %, based on the total weight of the photocurable composition 1000. In some embodiments, the surface additive may be included in an amount of about 0.1 wt % to about 1 wt %, based on the total weight of the photocurable composition 1000.

When the surface additive is included in an amount of less than about 0.1 wt %, based on the total weight of the photocurable composition 1000, it may be difficult to ensure the leveling property and the application property when the photocurable composition 1000 is applied on the encapsulation layer TFE. When the surface additive is included in an amount of exceeding about 5 wt %, based on the total weight of the photocurable composition 1000, a stain may be caused by the unreacted material of the photocurable composition 1000 after curing.

In some embodiments, the functional raw material may further include at least one of an anti-static agent, a catalyst, an inorganic filler, an organic filler, metal powder, a pigment, a softener, a plasticizer, an age resistor, a conductive agent, a UV absorbing agent, a light stabilizer, a surface lubricating agent, a corrosion inhibitor, a heat stabilizer, a polymerization inhibitor, a lubricant, a degradation inhibitor (e.g., a light stabilizer), a silane coupling agent, an adhesion promoter, a thermal polymerization inhibitor, or a saturated fatty acid having eight or more carbons, within a range in which the effect of the present disclosure is not damaged.

For example, the silane coupling agent may include at least one selected from the group consisting of vinyltrimethoxy silane, vinyltriethoxy silane, trimethoxysilane (metha)acrylate, and vinyltriethoxysilane (metha)acrylate. For example, the thermal polymerization inhibitor may include at least one selected from the group consisting of hydroquinone, methyl ether hydroquinone, and 2,6-di-tert-butyl-4-methylphenol. The functional raw material may include one or more suitable materials in the art.

### (4) Photoinitiator

The photoinitiator may be excited by ultraviolet light and/or the like to function to initiate photopolymerization. The photoinitiator may include, for example, at least one of a phosphine-based photoinitiator, a hydroxy ketone-based photoinitiator, a carbonyl-based photoinitiator, a sulfide-based photoinitiator, a quinone-based photoinitiator, an azo-based photoinitiator, or a peroxide-based photoinitiator.

In some embodiments, the photoinitiator may include a phosphine-based photoinitiator and a hydroxy ketone-based photoinitiator. The phosphine-based photoinitiator may be a photoinitiator in a long wavelength (e.g., about 395 nm). The hydroxy ketone-based photoinitiator may be a photoinitiator in a short wavelength (e.g., about 305 nm).

In some embodiments, the photoinitiator may include at least one selected from the group consisting of benzophenone, benzyl, benzoin, acetophenone, 2,2-diethoxyacetophenone, 2,2-dimethoxy-2-phenylacetophenone, p-dimethylaminoacetophenone, p-dimethylaminopropiophenone, p,p′-bisdiethylaminobenzophenone, benzoinmethylether, benzoinisobutylether, benzoin-n-butylether, 1-hydroxycyclohexylphenylketone, 2-hydroxy-2-methyl-1-phenyl-propane-1-on, 1-(4-isopropylphenyl)-2-hydroxy-2-methylpropane-1-on, 2,2-diethoxyacetophenone, 4-N,N′-dimethylacetophenone, benzoquinone, anthraquinone, diphenyldisulfide, dibenzyldisulfide, tetraethylthiuramdisulfide, tetramethylammoniummonosulfide, azobisisobutyronitryl, 2,2′-azobispropane, hydrazine, thioxanthone, 2-methylthioxanthone peroxidebenzoyl, di-t-butylperoxide, 2,4,6-trimethylbenzoyl-diphenyl-phosphineoxide, 2-methyl-1-[4-(methylthio)phenyl]-2-morpholino-propane-1-on, 2-hydroxy-1-4-[4-(2-hydroxy-2-methyl-prophionyl)-benzyl]-phynyl-2-methyl-propane-1-on, methyl phenylglyoxylate, 2-benzly-2-(dimethylamino)-1-[4-(4-morpholinyl)phenyl]-1-butanone, and 2-methyl-1-[4-(methylthio)phynly]-2-(4-morpholinyl)-1-propanone. However, the present disclosure is not limited thereto, and ordinary photoinitiators in the art may be utilized without limitation.

In some embodiments, the phosphine-based photoinitiator may be phenylbis(2,4,6-trimethylbenzoil)phosphine oxide. In some embodiments, the hydroxy ketone-based photoinitiator may be 1-hydroxycyclohexyl phenyl ketone.

In some embodiments, the photocurable composition 1000 may further include a photosensitizer to improve the photoinitiation efficiency of the photoinitiator. In some embodiments, the photosensitizer may be at least one of thioxanthone or benzophenone derivatives.

The photoinitiator may be included in an amount of about 0.1 wt % to about 10 wt %, based on the total weight of the photocurable composition 1000. In some embodiments, the photoinitiator may be included in an amount of about 0.1 wt % to about 5 wt %, based on the total weight of the photocurable composition 1000. In some embodiments, the photoinitiator may be included in an amount of about 0.1 wt % to about 3 wt %, based on the total weight of the photocurable composition 1000. In some embodiments, the phosphine-based photoinitiator may be included in an amount of about 0.1 wt % to about 3 wt %, based on the total weight of the photocurable composition 1000. In some embodiments, the hydroxy ketone-based photoinitiator may be included in an amount of about 0.1 wt % to about 3 wt %, based on the total weight of the photocurable composition 1000.

When the photoinitiator is included in an amount of less than about 0.1 wt %, based on the total weight of the photocurable composition 1000, photoinitiation does not occur, and therefore, it may be difficult to ensure the hardening modulus of a cured product. When the photoinitiator is included in an amount exceeding about 10 wt %, based on the total weight of the photocurable composition 1000, a yellow index may be increased to about 1 or more, and migration after curing may occur due to an unreacted initiator.

The photocurable composition 1000 of the present disclosure includes each of the oligomer, the monomer, the functional raw material, and the photoinitiator by a weight corresponding to the above-described numerical value range, to be rapidly cured by ultraviolet light when the display device DD is manufactured, thereby forming (or providing) the protective film PF. Also, the photocurable composition 1000 allows the protective film PF to have appropriate or suitable adhesion, so that the protective film PF can be readily removed after the protective film PF is formed (or provided).

Hereinafter, a method of manufacturing the display device, which includes a method of forming (or providing) the protective film PF, utilizing the photocurable composition 1000 in accordance with the present disclosure, will be described with reference to FIGS. 3 to 10.

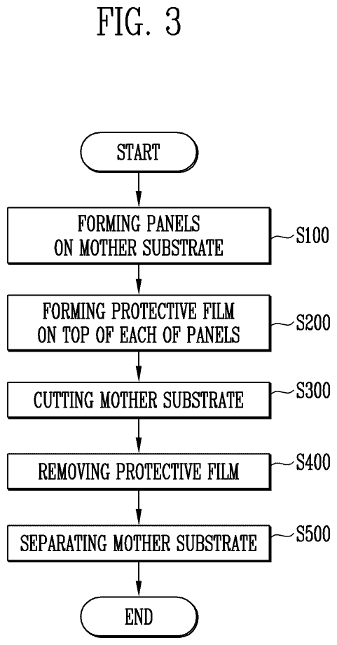

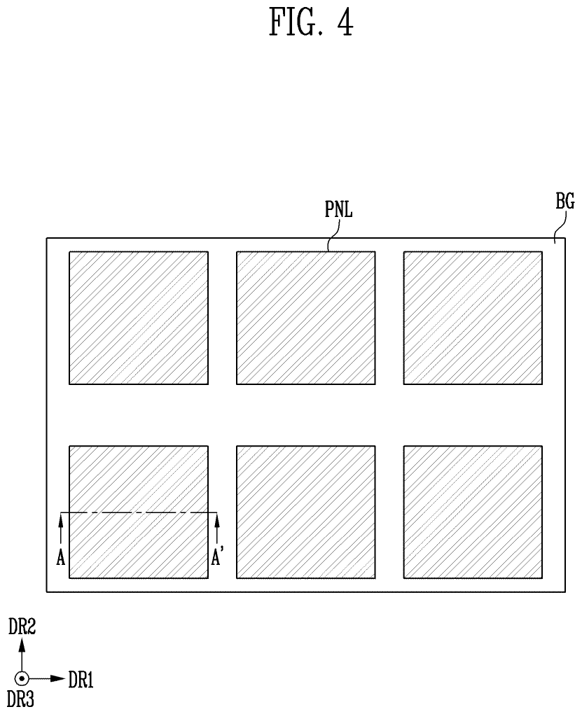

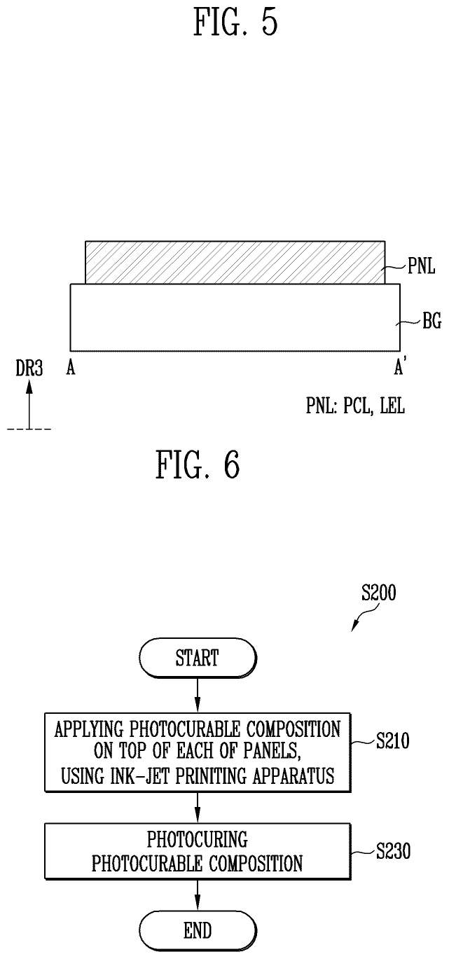

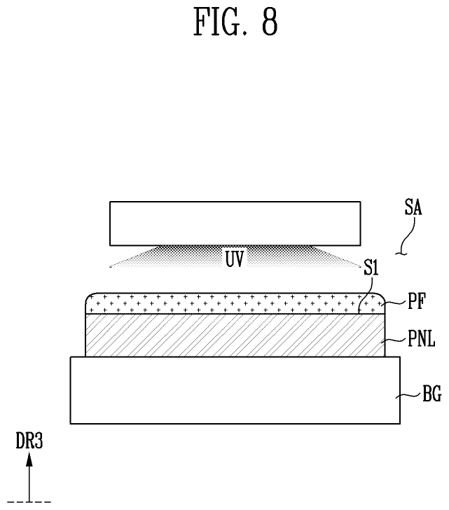

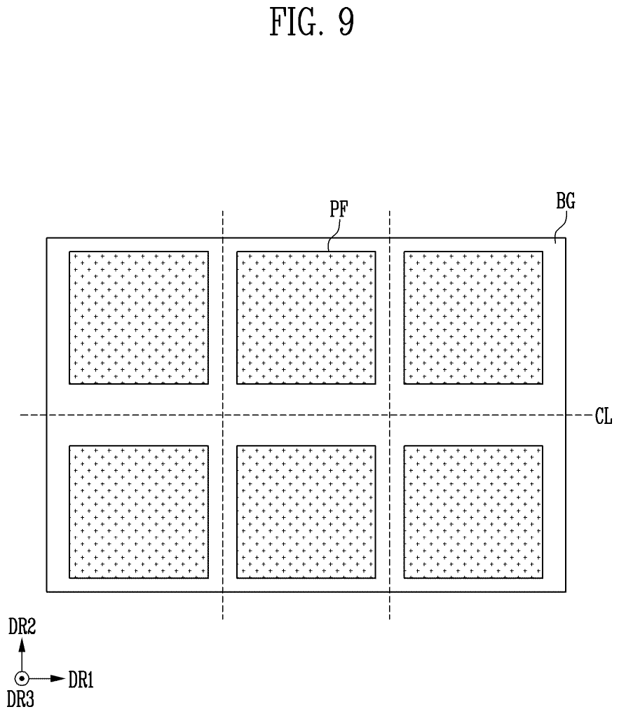

FIG. 3 is a schematic flowchart illustrating a method of manufacturing the display device in accordance with some embodiments of the present disclosure. FIG. 4 is a schematic plan view illustrating step (e.g., act or task) S100 shown in FIG. 3. FIG. 5 is a schematic cross-sectional view taken along line A-A′ shown in FIG. 4. FIG. 6 is a schematic flowchart illustrating step S200 shown in FIG. 3. FIGS. 7 and 8 are schematic cross-sectional views illustrating process steps shown in FIG. 5. FIG. 9 is a schematic plan view illustrating step S300 shown in FIG. 3. FIG. 10 is a schematic cross-sectional view illustrating step S400 shown in FIG. 3.

Referring to FIG. 3, the method of manufacturing the display device DD may include step S100 of forming (or providing) panels on a mother substrate, step S200 of forming (or providing) a protective film on the top of each of the panels, step S300 of cutting the mother substrate, step S400 of removing the protective film, and step S500 of separating the mother substrate.

Referring to FIGS. 2, 4, and 5, in the step S100 of forming (or providing) the panels on the mother substrate, a plurality of panels PNL may be formed (or provided) on a mother substrate BG. The mother substrate BG may be a substrate which supports the plurality of panels PNL before the plurality of panels PNL are separated into individual panels PNL. In some embodiments, the mother substrate BG may be a glass substrate, but the present disclosure is not limited thereto.

In the step (e.g., act or task) of forming (or providing) the panels PNL, base layers BSL may be disposed on the mother substrate BG, and a pixel circuit layer PCL including a pixel circuit for driving light emitting elements LD may be formed (or provided) on each base layer BSL. The pixel circuit layer PCL may be formed (or provided) to include conductive layers and insulating layers disposed between the conductive layers. Here, any element in a claim that does not explicitly state “means for” performing a specified function, or “step for” performing a specific function, is not to be interpreted as a “means” or “step” clause as specified in 35 U.S.C. § 112 (f). In particular, the use of “step of” or “act of” in the claims herein is not intended to invoke the provisions of 35 U.S.C. § 112 (f).

In some embodiments, components disposed on the base layer BSL may be formed (or provided) through an ordinary patterning process (e.g., a photolithography process and/or the like) utilizing a mask.

After the pixel circuit layer PCL is formed (or provided), a first electrode ELT1 may be formed (or provided). The first electrode ELT1 may be deposited on the pixel circuit layer PCL and then etched. In some embodiments, the first electrode ELT1 may be electrically connected to a driving transistor through a hole penetrating a protective layer in the pixel circuit layer PCL when the first electrode ELT1 is deposited. The first electrode ELT1 may be etched such that at least a portion of the pixel circuit layer PCL is exposed.

In the present disclosure, at least one of a Chemical Vapor Deposition (CVD) process and an Atomic Layer Deposition (ALD) may be utilized as a process for depositing a component of the display device DD. In the present disclosure, at least one of wet etching or dry etching may be utilized as an etching process. However, the present disclosure is not limited to a specific example.

After the first electrode ELT1 is formed (or provided), a pixel defining layer PDL may be formed (or provided). The pixel defining layer PDL may be etched after the pixel defining layer PDL is deposited on the pixel circuit layer PCL. The pixel defining layer PDL may be etched to expose at least a portion of the first electrode ELT1. The pixel defining layer PDL may be etched to overlap with the other portion of the first electrode ELT1 in a plan view.

After the pixel defining layer PDL is formed (or provided), a light emitting portion EL may be formed (or provided). The light emitting portion EL may be formed (or provided) in an area defined by the pixel defining layer PDL. The light emitting portion EL may be formed (or provided) in an opening formed (or provided) by the pixel defining layer PDL.

After the light emitting portion EL is formed (or provided), a second electrode ELT2 may be formed (or provided). The second electrode ELT2 may be deposited on the pixel defining layer PDL and the light emitting portion EL and then etched.

After the second electrode ELT2 is formed (or provided), an encapsulation layer TFE may be formed (or provided). The encapsulation layer TFE may be formed (or provided) over the second electrode ELT2. The encapsulation layer TFE may entirely cover the second electrode ELT2. In some embodiments, the encapsulation layer TFE may be formed (or provided) to have a structure in which an inorganic layer and an organic layer are alternately stacked.

After the plurality of panels PNL are formed (or provided), each of the panels PNL may be cut to form (or provide) the display device DD. Before each of the panels PNL is cut, a protective film PF may be formed (or provided) on the top of each of the panels PNL. Referring to FIG. 6, the step S200 of forming (or providing) the protective film on the top of each of the panels may include step S210 of applying a photocurable composition on the top of each of the panels, utilizing an ink-jet printing apparatus and step S230 of photocuring the photocurable composition.

Referring to FIG. 7, in the step S210 of applying the photocurable composition on the top of each of the panels, utilizing the ink-jet printing apparatus, a photocurable composition 1000 may be applied on the panel PNL through an ink-jet printing apparatus 100.

According to the method of manufacturing the display device DD in accordance with some embodiments of the present disclosure, when the protective film pF is formed (or provided) on the panel PNL, the photocurable composition 100 for forming (or providing) the protective film PF may be applied through an ink-jet printing process, and be cured by light (e.g., ultraviolet light).

In some embodiments, in order to protect the panel PNL, a protective layer including polyethylene terephthalate was formed (or provided) to entirely cover the mother substrate BG. After the protective layer was attached on the panel PNL through a laminating process, at least a portion of the protective layer was cut utilizing laser, so that the protective layer was formed (or provided) in a desired or suitable area (e.g., an area corresponding to the panel PNL). As the process concurrently (e.g., simultaneously) included a process of laminating the protective layer on the panel PNL and a process of cutting the protective layer, the number of process steps for forming (or providing) the protective layer was increased. Therefore, the manufacturing yield related to the manufacturing process of a display device was decreased. In some embodiments, the laser precision of a laser cutting process for forming (or providing) the protective layer in the desired or suitable area was required or desired.

On the other hand, according to the method of manufacturing the display device DD of the present disclosure, the protective film PF may be manufactured utilizing a method in which the photocurable composition 1000 is applied through the ink-jet printing process and then cured by light. As the photocurable composition 1000 is applied through the ink-jet printing process, the protective film PF is readily formed (or provided) in a desired or suitable area, and any process for laminating the protective film PF is not additionally performed. Hence, the manufacturing process can be simplified. Accordingly, the manufacturing yield of the display device DD can be increased.

The photocurable composition 1000 may be discharged through the ink-jet printing apparatus 100. The photocurable composition 1000 may be injected into the ink-jet printing apparatus 100, to be discharged through nozzles included in the ink-jet printing apparatus 100. The photocurable composition 1000 may have a viscosity of about 15 cps to about 25 cps and a surface tension of about 20 dyne/cm to about 30 dyne/cm under about 25° C.

When the photocurable composition 1000 has a viscosity of less than about 15 cps and a surface tension of less than about 20 dyne/cm under about 25° C., the photocurable composition 1000 may not be discharged at some nozzles of the ink-jet printing apparatus 100 when the photocurable composition 1000 is discharged from the ink-jet printing apparatus 100. This may cause a stain (e.g., a mark remains in a partial area on the panel PNL because the photocurable composition 1000 is not applied) to remain in the protective film PF. When the photocurable composition 1000 has a viscosity of exceeding about 25 cps and a surface tension exceeding about 30 dyne/cm under about 25° C., the photocurable composition 1000 is excessively discharged at the nozzles of the ink-jet printing apparatus 100, and therefore, mura may occur at a surface of the protective film PF. The occurrence of the stain and the mura may be recognized as a defect in an inspecting process.

As the photocurable composition 1000 in accordance with some embodiments of the present disclosure has a viscosity of about 15 cps to about 25 cps and a surface tension of about 20 dyne/cm to about 30 dyne/cm under about 25° C., the occurrence of the stain and the mura can be reduced.

When the photocurable composition 1000 is discharged, the temperature of the nozzles (or heads) of the ink-jet printing apparatus 100 may be included in a range of about 30° C. to about 50° C. In some embodiments, the temperature of the nozzles (or heads) of the ink-jet printing apparatus 100 may be included in a range of about 35° C. to about 40° C. When the temperature of the nozzles (or heads) of the ink-jet printing apparatus 100 is less than about 30° C., the photocurable composition 1000 may not be discharged at some nozzles of the ink-jet printing apparatus 100. When the temperature of the nozzles (or heads) of the ink-jet printing apparatus 100 exceeds about 50° C., the durability of the nozzles (or heads) of the ink-jet printing apparatus 100 may be decreased, and the roughness of the protective film PF may be increased as the photocurable composition 1000 is excessively discharged at the nozzles of the ink-jet printing apparatus 100.

In the method of manufacturing the display device DD in accordance with some embodiments of the present disclosure, as the photocurable composition 1000 is discharged from the nozzles (or heads) of the ink-jet printing apparatus 100, which are in the range of about 30° C. to about 50° C. when the protective film PF is formed (or provided), the photocurable composition 1000 can be discharged by an appropriate or suitable amount, a risk that the durability of the nozzles (or heads) of the ink-jet printing apparatus 100 will be decreased can be reduced, and the roughness of the protective film PF can be substantially uniform.

The photocurable composition 1000 may be discharged from the ink-jet printing apparatus 100, to be applied on one surface of the panel PNL. The photocurable composition 1000 may entirely cover the one surface of the panel PNL. For example, the photocurable composition 1000 may entirely cover a first surface S1 of the panel PNL. The first surface S1 of the panel PNL may be a surface spaced apart from the mother substrate BG. The first surface S1 of the panel PNL may be an upper surface of the panel PNL. In the present disclosure, an upper direction is defined as a thickness direction of the base layer BSL (e.g., the third direction DR3). As the photocurable composition 1000 is applied, an end portion of the photocurable composition 1000 and an end portion of the panel PNL may accord with each other.

After the photocurable composition 1000 is applied on the panel PNL, in the step S230 of photocuring the photocurable composition, the photocurable composition 1000 may be cured by light. Referring to FIG. 8, the photocurable composition 1000 may be cured by ultraviolet light UV, to form (or provide) the protective film PF. The protective film PF may be formed (or provided) to have a thickness of about 30 μm to about 150 μm, but the present disclosure is not limited thereto. An end portion of the protective film PF and an end portion of the panel PNL may correspond to each other. The end portion of the protective film PF and the end portion of the panel PNL may correspond with each other.

The ultraviolet light UV may have a wavelength of about 350 nm to about 400 nm. A cumulative light quantity (e.g., a total light quantity) of the ultraviolet light UV may be about 3 J/cm² to about 5 J/cm². In some embodiments, a cumulative light quantity (e.g., a total light quantity) of the ultraviolet light UV may be about 4 J/cm². When a cumulative light quantity (e.g., a total light quantity) of the ultraviolet light UV is less than about 3 J/cm², the surface (e.g., the first surface S1) is not cured, and therefore, tackiness (or stickiness) may occur at the surface of the protective film PF. When a cumulative light quantity (e.g., a total light quantity) of the ultraviolet light UV exceeds about 5 J/cm², the curing degree of the protective film PF may be saturated.

In the step S230 of photocuring the photocurable composition, a space SA in which curing of the photocurable composition 1000 occurs (e.g., an area in contact with the protective film PF) may have an oxygen (O₂) concentration of about 100 ppm to about 5000 ppm. The protective film PF may be formed (or provided) under an oxygen (O₂) atmosphere of about 100 ppm to about 5000 ppm. When the space SA in which the curing of the photocurable composition 1000 occurs has an oxygen (O₂) concentration of less than about 100 ppm, the protective film may not be exfoliated when the protective film PF is exfoliated from the panel PNL. For example, as the protective film PF is excessively cured, the protective film PF may not be exfoliated from the panel PNL. When the space SA in which the curing of the photocurable composition 1000 occurs has an oxygen (O₂) concentration of exceeding about 5000 ppm, tackiness (or stickiness) may occur at the surface of the protective film PF. For example, as the protective film PF is not cured, the stickiness of the surface of the protective film PF may be increased.

The protective film PF cured under an oxygen (O₂) concentration of about 100 ppm to about 5000 ppm by the ultraviolet light UV which has a wavelength of about 350 nm to about 400 nm and a cumulative light quantity of about 3 J/cm² to about 5 J/cm² may have a hardness of about 0.7 GPa to about 2 GPa. The protective film PF may have an elongation rate of about 10% to about 50%. The transmittance of the protective film PF may be about 90% or more. The curing index of the protective film PF may be about 85% to about 95% in a FT-IR measurement.

Referring to FIG. 9, after the protective film PF is formed (or provided), in the step S300 of cutting the mother substrate, the mother substrate BG may be cut along cutting lines CL. In a plan view, the cutting lines CL may be formed (or provided) to be spaced apart from corners of the protective film PF along an edge of the protective film PF. As the mother substrate BF is cut, the plurality of panels PNL may be separated into individual panels PNL.

Referring to FIG. 10, in the step S400 of removing the protective film, the protective film PF on the panel PNL may be removed utilizing an exfoliation tape 300. In some embodiments, the exfoliation tape 300 may be wound around a roller and/or the like. In some embodiments, the exfoliation tape 300 may be one of a thermal exfoliation tape of which adhesion is weakened through heating, an ultraviolet exfoliation tape of which adhesion is weakened through irradiation of ultraviolet light, and a weak adhesive tape of which adhesion is weak in an ordinary state. The exfoliation tape 300 may have an adhesive strength of about 100 gf/inch or more.

A property change of the protective film PF in accordance with the present disclosure may be minimized or reduced at high temperature and high humidity. For example, although the protective film PF is exposed at about 120° C. for about a week, any cracks may not occur in the protective film PF. For example, although the protective film PF is exposed at about 85° C. for about 500 hours, any cracks may not occur in the protective film PF.

Thus, although the panels PNL are exposed to high temperature and high humidity in a process of carrying the panels PNL, the protective film PF in accordance with some embodiments of the present disclosure can stably protect the panels PNL. The risk that the protective film PF will be damaged (e.g., occurrence of cracks) is reduced, the protective film PF can be appropriately exfoliated.

When cracks occur in the protective film PF, the protective film PF may be broken when the protective film PF is exfoliated, and the encapsulation layer TFE may be stripped as the protective film PF is not exfoliated. The protective film PF in accordance with some embodiments of the present disclosure can reduce a risk that cracks will occur at high temperature and high humidity. In some embodiments, the protective film PF in accordance with some embodiments of the present disclosure that can be appropriately exfoliated.

When the protective film PF is exfoliated, the encapsulation layer TFE may be exposed. The first surface S1 of the encapsulation layer TFE, from which the protective film PF is removed, may have a hydrophobic surface. As the encapsulation layer TFE has the hydrophobic surface, a case where a contact angle of water is measured when the water drops on the first surface S1 after the protective film PF is exfoliated, the contact angle of the water may be increased as compared with before the protective film PF is formed (or provided).

In the step S500 of separating the mother substrate, the mother substrate BG may be separated from the panels PNL. A process of separating the mother substrate BG from the panels PNL may be a Laser Lift-Off (LLO) process. However, the present disclosure is not limited thereto. After the mother substrate BG is separated from the panels PNL, the display device DD may be completed.

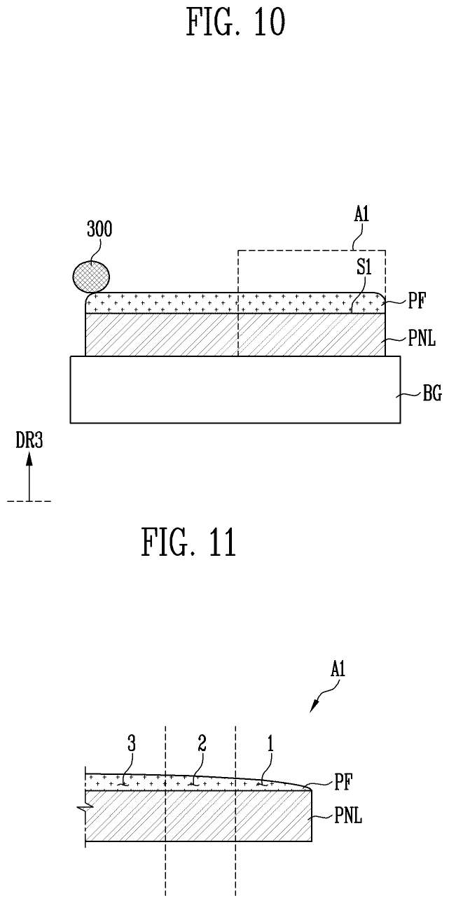

Hereinafter, characteristics of the protective film PF will be further described with reference to FIG. 11. FIG. 11 is an enlarged view schematically illustrating the panel and the protective film.

Referring to FIG. 11, the protective film PF may include a first portion 1, a second portion 2, and a third portion 3. The first portion 1 may be an edge area (e.g., an edge portion) of the protective film PF. The third portion 3 may be a central area of the protective film PF. The second portion 2 may be an area located between the first portion 1 and the third portion 3.

The protective film PF may have a thickness which becomes thicker as approaching the third portion 3 from the first portion 1. The protective film PF may have a thickness which becomes thicker as approaching the central area from the edge area. In the protective film PF, the third portion 3 may have a thickness thicker than a thickness of the first portion 1. As the protective film PF is formed (or provided) to have a thickness difference, the quantity of the photocurable composition 1000 exposed to ultraviolet light may vary when the photocurable composition 1000 is cured. For example, experimentally, the first portion 1 having a thickness thinner than the thickness of the third portion 3 may be more exposed (e.g., the first portion 1 may be more exposed to the ultraviolet light than) as compared to/with the third portion 3. Because the quantity of the protective film PF exposed to the ultraviolet light varies, the first portion 1 and the third portion 3 may have different curing degrees. For example, as the first portion 1 is exposed relatively large (e.g., is more exposed) as compared with the third portion 3, a curing degree of the first portion 1 may be greater than a curing degree of the third portion 3.

Because the curing degree of the third portion 3 and the curing degree of the first portion 1 are different from each other, a stress difference may occur in the protective film PF when the protective film PF is formed (or provided). When the stress difference occurs in the protective film PF, an exfoliation strength for exfoliating the protective film PF may vary. For example, the exfoliation strength may become smaller as approaching the central area (e.g., the third portion 3) of the protective film PF. For example, when the protective film PF is formed (or provided) under an oxygen (O₂) atmosphere of about 500 ppm, the first portion 1 may have an exfoliation strength of about 10 gf/inch to about 30 gf/inch. For example, the third portion 3 may have an exfoliation strength of about 1 gf/inch to about 5 gf/inch.

The exfoliation strength is a property value representing the magnitude of a force required when the protective film PF is exfoliated from the panel PNL. The exfoliation strength may vary according to the curing degree of a material. For example, the exfoliation strength may be increased as the curing degree of the material is increased.

When the protective film PF is exfoliated with different exfoliation strengths in some areas, a residual pattern (e.g., an uneven pattern formed (or provided) at a portion of the surface of the encapsulation layer TFE) may be formed (or provided) on the encapsulation layer TFE.

In accordance with the present disclosure, there can be provided photocurable compositions and a method of manufacturing a display device, utilizing photocurable compositions, which can simplify a manufacturing process of a protective film for protecting a panel in a manufacturing process of the display device.

In accordance with the present disclosure, there can be provided photocurable compositions and a method of manufacturing a display device, utilizing photocurable compositions, which can minimize or reduce a property change of a protective film under a harsh environment (e.g., a high temperature and humid environment).

In the present disclosure, singular expressions may include plural expressions unless the context clearly indicates otherwise. It will be further understood that the terms “comprise(s),” “include(s),” or “have/has” when utilized in the present disclosure, specify the presence of stated features, integers, steps, operations, elements, and/or components, but do not preclude the presence or addition of one or more other features, integers, steps, operations, elements, components, and/or groups thereof. The “/” utilized herein may be interpreted as “and” or as “or” depending on the situation.

Throughout the present disclosure, when a component such as a layer, a film, a region, or a plate is mentioned to be placed “on” another component, it will be understood that it may be directly on another component or that another component may be interposed therebetween. In some embodiments, “directly on” may refer to that there are no additional layers, films, regions, plates, etc., between a layer, a film, a region, a plate, etc. and the other part. For example, “directly on” may refer to two layers or two members are disposed without utilizing an additional member such as an adhesive member therebetween.

In the present disclosure, although the terms “first,” “second,” etc., may be utilized herein to describe one or more elements, components, regions, and/or layers, these elements, components, regions, and/or layers should not be limited by these terms. These terms are only utilized to distinguish one component from another component.

As utilized herein, the singular forms “a,” “an,” “one,” and “the” are intended to include the plural forms as well, unless the context clearly indicates otherwise. Further, the use of “may” when describing embodiments of the present disclosure refers to “one or more embodiments of the present disclosure”.

In the present disclosure, when particles (e.g., nanoparticles) are spherical, “size” indicates a particle diameter or an average particle diameter, and when the particles are non-spherical, the “size” indicates a major axis length or an average major axis length. The diameter (or size) of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

In present disclosure, “not include a or any ‘component’” “exclude a or any ‘component”, “component’-free”, and/or the like refers to that the “component” not being added, selected, or utilized as a component in a compound/composition/structure, but the “component” of less than a suitable amount may still be included due to other impurities and/or external factors in a composition.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

As utilized herein, the term “and/or” includes any and all combinations of one or more of the associated listed items. Throughout the disclosure, the expression “at least one of a, b or c”, “at least one of a-c”, “at least one of a to c”, “at least one of a, b, and/or c”, “at least one among a to c”, etc., indicates only a, only b, only c, both (e.g., simultaneously) a and b, both (e.g., simultaneously) a and c, both (e.g., simultaneously) b and c, all of a, b, and c, or variations thereof.

In the present specification, “including A or B”, “A and/or B”, etc., represents A or B, or A and B.

The light-emitting device, the display device, the electronic apparatus, the electronic equipment, or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Example embodiments have been disclosed herein, and although specific terms are employed, they are utilized and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be utilized singularly or in combination with features, characteristics, and/or elements described in connection with other embodiments unless otherwise specifically indicated. Accordingly, it will be understood by those of skill in the art that one or more suitable changes in form and details may be made without departing from the spirit and scope of the present disclosure as set forth in the following claims and equivalents thereof.

What is claimed is:

1. A photocurable composition comprising:
a photocurable oligomer;
a photocurable monomer comprising a monofunctional (metha)acrylate monomer and a polyfunctional (metha)acrylate monomer;
a functional raw material comprising an antioxidant and a surface additive; and
a photoinitiator,
wherein the photocurable oligomer comprises at least one of (metha)acrylate, polyether-based (metha)acrylate, epoxy (metha)acrylate, or urethane (metha)acrylate, and
wherein the photocurable oligomer is in an amount of about 15 wt % to about 25 wt %, based on a total weight of the photocurable composition, and has a weight-average molecular weight of about 500 g/mol to about 10000 g/mol.

2. The photocurable composition of claim 1, wherein the monofunctional (metha)acrylate monomer comprises at least one of 2-hydroxyethyl (metha)acrylate, 2-hydroxypropyl (metha)acrylate, 4-hydroxybutyl acrylate, methyl(metha)acrylate, n-butyl (metha)acrylate, t-butyl(metha)acrylate, isobutyl(metha)acrylate, n-hexyl (metha)acrylate, stearyl(metha)acrylate, lauryl(metha)acrylate, isononylacrylate, tridecyl(metha)acrylate, cyclohexyl(metha)acrylate, norbornyl(metha)acrylate, isobornyl(metha)acrylate, norbornanyl(metha)acrylate, dicyclopentenyl(metha)acrylate, dicyclopentenyloxyethyl(metha)acrylate, dicyclopentanyl(metha)acrylate, or dicyclopentanyloxyethyl(metha)acrylicvinylnorbornylon, and
wherein the polyfunctional (metha)acrylate monomer comprises at least one of ethyleneglycoldimethacrylate, diethyleneglycoldimethacrylate, 1,6-hexanedioldimethacrylate, trimethylolpropanetrimethacrylate, pentaerythritol tetraacrylate, dipentaerythritolpenta(metha)acrylate, dipentaerythritomonohydroxypenta(metha)acrylate, or dipropyleneglycoldiacrylate.

3. The photocurable composition of claim 2, wherein the monofunctional (metha)acrylate monomer is in an amount of about 65 wt % to about 75 wt %, based on the total weight of the photocurable composition, and
wherein the polyfunctional (metha)acrylate monomer is in an amount of about 1 wt % to about 50 wt %, based on the total weight of the photocurable composition.

4. The photocurable composition of claim 3, wherein the photocurable monomer has a viscosity in a range of about 1 cps to about 1000 cps under about 25° C.

5. The photocurable composition of claim 2, wherein the antioxidant comprises at least one selected from the group consisting of IRGANOX 1135, IRGANOX 1035, IRGANOX 1520L, IRGANOX 1076, IRGANOX 1010, IRGAFOS 168, and IRGAFOS 126 which are manufactured by IGA (IGM Resins B.V.) and/or 2,2′-thiodiethylene bis [3-(3,5-di-tert-butyl-4-hydroxyphenyl) propionate].

6. The photocurable composition of claim 5, wherein the antioxidant is in an amount of about 0.001 wt % to about 5 wt %, based on the total weight of the photocurable composition.

7. The photocurable composition of claim 2, wherein the surface additive comprises at least one of a polyacrylate-based surfactant, a silicon containing surfactant, or acrylic-based surfactant.

8. The photocurable composition of claim 7, wherein the surface additive is in an amount of about 0.1 wt % to about 5 wt %, based on the total weight of the photocurable composition.

9. The photocurable composition of claim 5, wherein the photoinitiator comprises at least one of benzophenone, benzyl, benzoin, acetophenone, 2,2-diethoxyacetophenone, 2,2-dimethoxy-2-phenylacetophenone, p-dimethylaminoacetophenone, p-dimethylaminopropiophenone, p,p′-bisdiethylaminobenzophenone, benzoinmethylether, benzoinisobutylether, benzoin-n-butylether, 1-hydroxycyclohexylphenylketone, 2-hydroxy-2-methyl-1-phenyl-propane-1-on, 1-(4-isopropylphenyl)-2-hydroxy-2-methylpropane-1-on, 2,2-diethoxyacetophenone, 4-N,N′-dimethylacetophenone, benzoquinone, anthraquinone, diphenyldisulfide, dibenzyldisulfide, tetraethylthiuramdisulfide, tetramethylammoniummonosulfide, azobisisobutyronitryl, 2,2′-azobispropane, hydrazine, thioxanthone, 2-methylthioxanthone peroxidebenzoyl, di-t-butylperoxide, 2,4,6-trimethylbenzoyl-diphenyl-phosphineoxide, 2-methyl-1-[4-(methylthio)phenyl]-2-morpholino-propane-1-on, 2-hydroxy-1-4-[4-(2-hydroxy-2-methyl-prophionyl)-benzyl]-phynyl-2-methyl-propane-1-on, methyl phenylglyoxylate, 2-benzly-2-(dimethylamino)-1-[4-(4-morpholinyl)phenyl]-1-butanone, or 2-methyl-1-[4-(methylthio)phynly]-2-(4-morpholinyl)-1-propanone.

10. The photocurable composition of claim 9, wherein the photoinitiator is in an amount of about 0.1 wt % to about 10 wt %, based on the total weight of the photocurable composition.

11. A method of manufacturing a display device, the method comprising:
forming panels on a mother substrate; and
forming a protective film on the top of each of the panels,
wherein the forming of the protective film on the top of each of the panels comprises:
applying a photocurable composition on the top of each of the panels utilizing an ink-jet printing apparatus; and
photocuring the photocurable composition,
wherein the photocurable composition comprises:
a photocurable oligomer;
a photocurable monomer comprising a monofunctional (metha)acrylate monomer and a polyfunctional (metha)acrylate monomer;
a functional raw material comprising an antioxidant and a surface additive; and
a photoinitiator,
wherein the photocurable oligomer comprises at least one of (metha)acrylate, polyether-based (metha)acrylate, epoxy (metha)acrylate, or urethane (metha)acrylate, and
wherein the photocurable oligomer is in an amount of about 15 wt % to about 25 wt %, based on a total weight of the photocurable composition, and has a weight-average molecular weight of about 500 g/mol to about 10000 g/mol.

12. The method of claim 11, wherein the monofunctional (metha)acrylate monomer is in an amount of about 65 wt % to about 75 wt %, based on the total weight of the photocurable composition, and
wherein the polyfunctional (metha)acrylate monomer is in an amount of about 1 wt % to about 50 wt %, based on the total weight of the photocurable composition.

13. The method of claim 12, wherein the antioxidant comprises at least one of a phenol-based antioxidant, a phosphor-based antioxidant, or a sulfur-based antioxidant, and is in an amount of about 0.001 wt % to about 5 wt %, based on the total weight of the photocurable composition, and
wherein the surface additive comprises at least one of a polyacrylate-based surfactant, a silicon containing surfactant, or acrylic-based surfactant, and is in an amount of about 0.1 wt % to about 5 wt %, based on the total weight of the photocurable composition.

14. The method of claim 13, wherein the photoinitiator comprises at least one of a phosphine-based photoinitiator, a hydroxy ketone-based photoinitiator, a carbonyl-based photoinitiator, a sulfide-based photoinitiator, a quinone-based photoinitiator, an azo-based photoinitiator, or a peroxide-based photoinitiator, and is in an amount of about 0.1 wt % to about 10 wt %, based on the total weight of the photocurable composition.

15. The method of claim 14, wherein the photocuring of the photocurable composition comprises curing the photocurable composition, utilizing ultraviolet light, and
wherein the ultraviolet light has a wavelength of about 350 nm to about 400 nm, and has a cumulative light quantity of about 3 J/cm² to about 5 J/cm².

16. The method of claim 15, wherein in the photocuring of the photocurable composition, the photocurable composition is cured under an oxygen concentration of about 100 ppm to about 5000 ppm.

17. The method of claim 14, further comprising removing the protective film,
wherein the removing of the protective film comprises removing the protective film, utilizing a tape comprising at least one of a thermal exfoliation tape, an ultraviolet exfoliation tape, or a weak adhesive tape, and
wherein when the protective film is removed, an exfoliation strength of the protective film becomes smaller as approaching a central area of the protective film.

18. The method of claim 14, wherein the photocurable composition has a viscosity of about 15 cps to about 25 cps and a surface tension of about 20 dyne/cm to about 30 dyne/cm under 25° C.,
wherein in the applying the photocurable composition on the top of each of the panels utilizing the ink-jet printing apparatus, the photocurable composition is applied through a head of the ink-jet printing apparatus, and
wherein the head has a temperature range of about 30° C. to about 50° C.

19. The method of claim 14, wherein the protective film is formed to have a thickness of about 30 μm to about 150 μm.

20. The method of claim 15, wherein the protective film has a curing index of about 85% to about 95% in a Fourier-transform infrared spectroscopy (FT-IR) measurement and a hardness of about 0.7 GPa to about 2 GPa.
